(19) United States
(12) Patent Application Publication
(10) Pub. No.: US 2010/0141949 A1
(43) Pub. Date: Jun. 10, 2010

(54) MEASURING OF FUEL COMPOSITION BY USING LASER

(75) Inventor: Renato Bugge, Trondheim (NO)

Correspondence Address: DENNISON, SCHULTZ & MACDONALD, 1727 KING STREET, SUITE 105, ALEXANDRIA, VA, 22314, US

(73) Assignee: INTEGRATED OPTOELECTRONICS AS, Trondheim (NO)

(21) Appl. No.: 12/666,810

(22) PCT Filed: Jun. 2, 2008
(86) PCT No.: PCT/NO08/00195

§ 371 Date: Jan. 19, 2010

(30) Foreign Application Priority Data
Jul. 9, 2007 (NO) 2007 3522

(51) Int. Cl. G01J 3/46

(52) U.S. Cl. 356/402

(57) ABSTRACT

A method is shown for the analysis of hydrocarbon based fuels comprising the following steps: a) the use of a tunable diode laser (TDL) whereby several wavelengths of light can be emitted, b). transmission of said light through a transparent flow cell or flow chamber containing the fuel, c). measurement of the transmitted light with an optical detector positioned on the opposite site of the cell/chamber, d). detection of signals and storage on a computer memory, e). computer-based analysis of measurements, f). use of an algorithm and a chemical reference library for subsequent quantitative analysis of the hydrocarbon compounds.

### FIELD OF THE INVENTION

The invention relates to use and a method for analyzing fuel by means of a laser, preferably one or more tunable laser(s), which can sweep (scan) one or more spectrums within the infrared wavelength region between 1 and 25 μm, according to the preamble of claim 1.

The spectral data provides the basis for analyzing the fuel, such that one mathematically can collect absorption data and compare it with a composite chemical library. By considering the different fuel components, the content of these in the fuel can be found, and thus one can calculate the optimal combustion proportions for the fuel.

The invention also relates to a system for performing the method, according to claim 11.

### BACKGROUND

One way to measure a chemical by light is to use wavelengths which are absorbed by the given chemical. This can today be done in a Fourier Transform Infrared (FTIR) spectrometer which has an IR lamp or IR diode as light source, and an interferometric filter which can consist of two accurately controlled mirrors. Alternatively a monochromator can be used, consisting of a grating which filters and sweeps the wavelength region by changing the angle of the light in relation to the grating. In both cases a broad banded optical source, and a detector to collect the light passing the filter is used.

The technique according to the invention is based on utilizing one or more tunable lasers which can provide light in the infrared area, to collect spectral information, before mirror or grating. The choice of the wavelength to collect information from is thus chosen directly at the source, and a filter is not needed for this.

Several types of lasers can be used, but they must be able to sweep a wavelength region, preferably without being dependent on large temperature changes or similar which can destroy the laser over time.

The light emitted from the laser will pass through the fuel having its composition analyzed, and next be collected in a detector. In this manner one will be able to analyze absorption data from the fuel within a wavelength region. For more complicated fuel with several components it can be necessary to use several lasers to gain enough spectral data to determine the composition. You then use either the same or a different detector and illuminate the fuel with each laser to collect absorption data from the different spectral regions.

An interferometric laser has earlier been developed (Norwegian Patent Application 20051589) which can provide light in the medium infrared (mid-IR) area. This laser can be utilized to perform the measurements described in this invention.

### OBJECT

The object of the invention is to provide a method for and a design for a system for analyzing of fuel by means of one or more tunable lasers which can sweep one or more spectral regions. It is also an object that this method shall provide data for controlling a motor, and that it may be used for different types of lasers.

### THE INVENTION

A method according to the invention is described in claim 1. Advantageous features of the method are described in claims 2-10.

A system for performing the method is described in claim 11. Advantageous features of the system are described in claim 12-17.

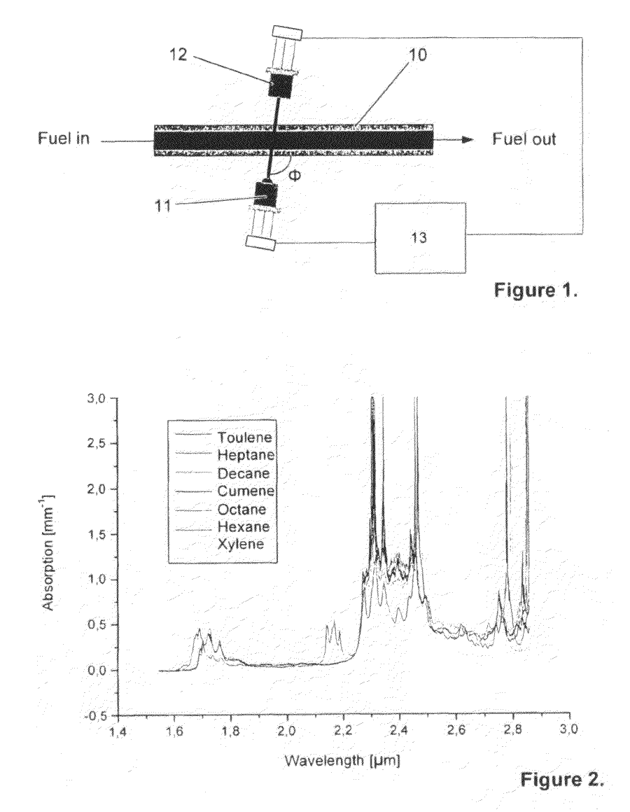

FIG. 1 is an example of a system according to the invention, arranged to measure transmission through flowing fuel. Absorption data is calculated from the transmission measurement.

A system for measuring the transmission through fuel includes, according to the invention, a chamber or container/flow line is a fuel, which chamber or container/flow line is transparent for the light which is used, one or more tunable lasers, one or more detectors, one microcontroller, and ordinary electronics.

An alternative of the arrangement would be to supply a part of the light to a reference detector with the light passing a reference material. In some cases the reference detector will be integrated in the laser components.

How the contents of components of the fuel are calculated will now be described.

In the case which is used for this description there are several fuel components. Absorption from each fuel component is stored in the system as a reference library, such that a best possible determination of the different fuel components of the fuel can be performed. There are two different methods for analyzing the content of the fuel.

The first method is based on choosing one or more spectral regions which have absorption of all the fuel components. The region is chosen such that the fuel component(s) have a moderate absorption in at least a part of this region, i.e. it does not result in a total damping of the optical signal or a damping which is not measurable. By measuring one point with absorption from all the components, this will reproduce the composition of a limited number of components given by the transmission:

$$T ( λ ) = \frac{I}{{I}_{0}} = exp ( - {α}_{1} ( λ ) * L * {ɛ}_{1} - {α}_{2} ( λ ) * L * {ɛ}_{2} - {α}_{3} ( λ ) * L * {ɛ}_{3} - … )$$

Where αₙ(A) is the absorption coefficient of fuel component n, λ is wavelength, L is the path length of the light, and εₙ is the concentration of fuel component n.

As long as it is at least as many measuring points with information about the fuel components as the number of components, the concentration of each component can be found. The measuring points must absorb the fuel components with different damping of the optical signal (different absorption factor for each point and each fuel component), as long as the absorption composition of each peak is different from the other peaks. If this requirement is obtained, the result is a set of mathematical equations with the same number of unknowns as equations, and they can be solved:

$$T ( {λ}_{1} ) = \frac{I}{{I}_{0}} = exp ( - {α}_{1} ( {λ}_{1} ) * L * {ɛ}_{1} - {α}_{2} ( {λ}_{1} ) * L * {ɛ}_{2} - {α}_{3} ( {λ}_{1} ) * L * {ɛ}_{3} - … )$$

$$T ( {λ}_{2} ) = \frac{I}{{I}_{0}} = exp ( - {α}_{1} ( {λ}_{2} ) * L * {ɛ}_{1} - {α}_{2} ( {λ}_{2} ) * L * {ɛ}_{2} - {α}_{3} ( {λ}_{2} ) * L * {ɛ}_{3} - … )$$

$$T ( {λ}_{3} ) = \frac{I}{{I}_{0}} = exp ( - {α}_{1} ( {λ}_{3} ) * L * {ɛ}_{1} - {α}_{2} ( {λ}_{3} ) * L * {ɛ}_{2} - {α}_{3} ( {λ}_{3} ) * L * {ɛ}_{3} - … )$$

Where λₘ is the wavelength for each peak m. A reference library with absorption data from the different fuel components results in a relation between the absorption coefficient αₙ(λₘ) for different wavelengths λₘ, such that:

αₙ(λ₁)=αₙ

αₙ(λ₂)=C_{n,212}αₙ(λ₁)=C_{n,212}αₙ

αₙ(λ₃)=C_{n,213}αₙ(λ₁)=C_{n,213}αₙ

Where C_{n,λ1x} is the relation between the absorption coefficient of the 1^{th} and 2^{th} of the absorption peaks. Rewritten this gives:

T(λ₁,ε₁,ε₂,ε₃,...)=exp(−L(α₁ε₁+α₂ε₂+α₃ε₃+. . . ))

T(λ₂,ε₁,ε₃,ε₃,...)=exp(−L(C_{1,212}α₁ε₁+C_{2,212}α₂ε₂+C_{3,212}α₃ε₃+...))

T(λ₃,ε₁,ε₂,ε₃,...)=exp(−L(C_{1,213}α₁ε₁+C_{2,213}α₂ε₂+C_{3,213}α₃ε₃+...))

As L, C_{n,λ1x} and αₙ are known, only T(λₘ) needs to be measured to find the concentrations εₙ for the different fuel components.

The other method for finding the concentration of fuel components consists of collecting the most possible data over a region between two wavelengths λₗ and λ₂. For collection a discrete number of points in this region are chosen. This results in a situation as for the first method, but with substantially more transmission measurements T(λₘ, ε₁, . . . , εₙ) than the number of unknown fuel components. To find the concentrations Eₙ for the different fuel components, a static fitting between real transmission measurements T_{R}(λₘ, ε₁, . . , εₙ) and calculated transmission T_{B}(λₘ, ε₁. . . , εₙ) from a chemical reference library must be done. In the fitting the calculated concentrations Eₙ are varied until the difference between the calculated and real measurements reaches a minimal tolerance. The propagation of the different values of Eₙ is dependent on several factors, such that the change of εₘ will form the basis for minimizing the difference between T_{R}(λₘ, εₗ, . . . , εₙ) and T_{B}(λₘ, ε₁, . . . ,εₙ).

To simplify the fitting, limited data regions can be used, where the absorption is large from some of the fuel components, but small from the others. The concentrations of some of the components can then be decided, such that the number of unknowns is reduced for fitting in other regions.

A method according to the invention for analyzing a fuel, preferably hydrocarbons, can be summarized in the following steps:

a) Tuning of a laser to send out different wavelengths of light,

b) Illumination with the laser light of a chamber or container/flow line holding fuel,

c) Measuring of transmitted laser light after it has passed the chamber/container/flow line with an optical detector,

d) Collecting and storing of measurements,

e) Analyzing the measurements by means of a microcontroller,

f) Calculate the concentrations by means of an algorithm arranged in the microcontroller and a chemical reference library.

Step a includes tuning of a laser to send out light of different wavelengths, which can be done in different ways, e.g. by altering the current, altering the temperature or altering both temperature and current.

Step b includes measurement of the absorbance in a chamber or container/flow line or similar with fuel through-put, which chamber or which container/flow line is transparent, where the amount of absorbed light is measured by means of a detector.

Step c includes collecting and storing of the measurements of step b by means of a microcontroller.

Step d includes processing and analyzing the measurements by means of one or more algorithms arranged in the microcontroller.

Step e includes calculating of the concentrations by means of an algorithm arranged in the microcontroller arranged for this and a chemical reference library stored in a memory of the microcontroller.

Step a may also include altering of work cycle and pulse current of the laser.

Step d will in such a case include filtering of the signal from the detector according to the pulse frequency of the laser.

Step b can also include measurement of light with a reference detector and a reference material to calibrate the wavelength of the light.

Step a-b can also include measurement by using IR-light in the area 1.0-10.0 μm.

Step a-b can also include measurement by using IR-light in the area 1.6-4.2 μm.

Step a-b can also include measurement by using IR-light in the area 2.1-2.9 μm.

FIG. 2 shows the measured absorption data from transmission measurements of some fuel components to build a chemical reference library. The library contains typically all the fuel components the system is supposed to take into consideration.

Further details of the invention will appear from the following example description.

### EXAMPLE

The invention will in the following be described in detail with references to the attached Figures, where:

FIG. 1 is a schematic assembly of a laser module for performing the method according to the invention,

FIG. 2 shows absorbance curves for some of the most general fuel components,

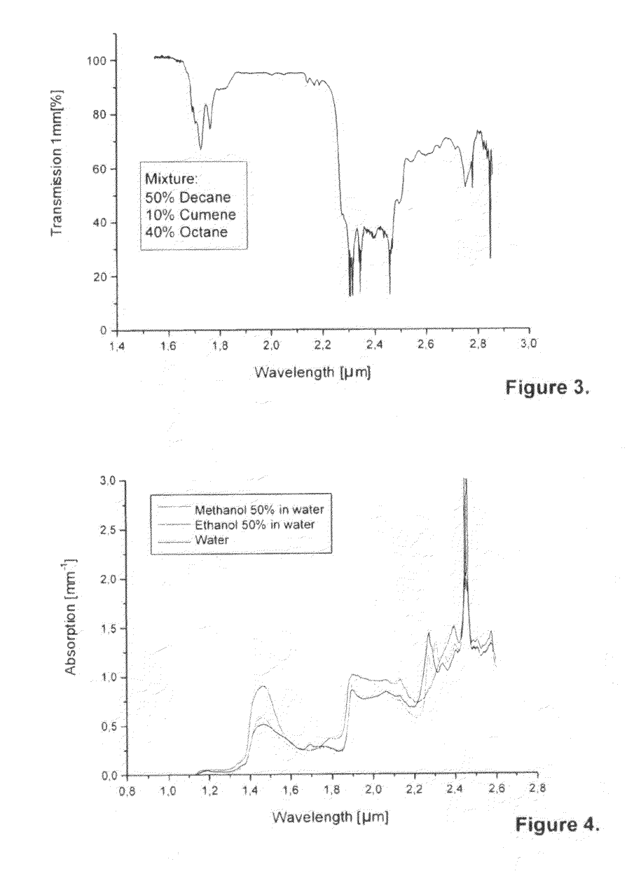

FIG. 3 shows a calculated transmission spectrum with different content of three general fuel components, and

FIG. 4 shows transmission curves for ethanol and methanol at 50% concentration in water, and pure water for comparison.

FIG. 1 is an example of an assembly of a laser module which is a part of a system according to the invention for measurement of fuel with a laser. Such an assembly includes a transparent chamber or a transparent container or flow line 10, through which chamber or container/flow line 10 a fuel flows. An assembly like this further includes a laser source 11 with integrated photo diode and a detector 12, for example, a photo diode or similar. Light is sent out from the laser source 11, through the transparent container/flow line 10 or chamber holding the fuel and out to the detector 12. The angle cp between the light from the laser source 11 and container 10 is chosen such that the reflected light does not affect the laser source 11. The system further includes a microcontroller 13, and other electronics. By sending a part of the light from the laser through the reference cell, the actual wavelength can be measured. The microcontroller is provided with algorithms and a reference library for performing the method according to the invention. As an alternative some of the light can be measured by a reference detector through a reference material with the purpose of measuring more accurately the wavelength and data.

FIG. 2 shows absorption data from some of the most common fuel components in the 1-3 μm wavelength region. The data shows that spectral information from the different components can be obtained which identifies these. The curves show special interesting peaks which clearly differing the different components. As can be seen from FIG. 2, absorption peaks of Cumene and Xylene are at 2.17 μm and 2.19 μm, respectively.

Decane gives strong, thin absorption peaks at both 2.35 and 2.45 μm which overlaps somewhat with Toluene and Hexane at 2.35 μm and Cumene at 2.45 μm. Toluene, Heptane, Decane and Hexane all contribute strongly to the absorption peak around 2.30 μm. Octane does not contribute strongly to any of the peaks, but has an absorbance around 2.40 which is relatively as high as for the other components. We thus have the following strong peaks:

2.17 μ—Cumene and Xylene

2.19 μ—Cumene and Xylene

2.45 μ—Decane and Cumene

2.35 μ—Toulene, Hexane and Cumene

2.30 μ—Toulene, Hexane, Decane and Heptane

2.40 μ—Toulene, Hexane, Decane, Heptane, Cumene, Xylene and Octane

Measuring at these peaks may result in total absorption, something that must be avoided if the concentrations are to be found. Total absorption can however be used to calibrate the wavelength, such that absorption measurements with high absorption are obtained, without getting total absorption. If a reference detector and a reference material are used, the wavelength will be calibrated with these.

FIG. 3 shows a calculated transmission spectrum for a fuel with three main components based on the absorption data shown in FIG. 2. Thin, acute absorption peaks with high absorbance have lower transmission than what appears from the Figure.

The example given in FIG. 3 shows a transmission spectrum of the three main components Octane, Decane and Cumene. By choosing the peaks at −2.19 μm, −2.35 μm and −2.40 μm enough data can be measured to find the concentrations of these three chemicals.

Plainly set up, we have, in other words (with simplified notation for the constants C_{xy} where x is wavelength and y is fuel component number):

T(λ₁,ε₁,ε₂,ε₃)=exp(−L(α₁ε₁+α₂ε₂+α₃ε₃))

T(λ₂,ε₁,ε₂,ε₃)=exp(−L(C₂₁α₁ε₁+C₂₂α₂ε₂+C₂₃α₃ε₃))

T(λ₃,ε₁,ε₂,ε₃)=exp(−L(C₃₁α₁ε₁+C₃₂α₂ε₃+C₃₃α₃ε₃))

The concentrations of the different materials are found by taking the logarithm of the two sides:

In|T(λ₁,ε₁,ε₂,ε₃)|·L⁻¹=−α₁ε₁,−α₂ε₂−α₃ε₃

In|T(λ₂,ε₁,ε₂,ε₃)|·L⁻¹=−C₂₁α₁ε₁−C₂₂α₂ε₂−C₂₃α₃ε₃

In|T(λ₂,ε₁,ε₂,ε₃)|·L⁻¹=−C₃₁α₁ε₁−C₃₂α₂ε₂−C₃₃α₃ε₃

Three equations with three unknowns which result in the solution:

$${ɛ}_{3} = \frac{{T}_{3} - {C}_{31} {T}_{1} - \frac{( {C}_{31} - {C}_{32} ) ( {C}_{21} {T}_{1} - {T}_{2} )}{( {C}_{22} - {C}_{21} )}}{{a}_{3} ( \frac{( {C}_{31} - {C}_{32} ) ( {C}_{21} - {C}_{23} )}{( {C}_{22} - {C}_{21} )} + ( {C}_{31} - {C}_{33} ) )}$$

$${ɛ}_{2} = \frac{{C}_{21} {T}_{1} - {T}_{2} + ( {C}_{21} - {C}_{23} ) {α}_{3} {ɛ}_{3}}{{α}_{2} ( {C}_{21} - {C}_{22} )}$$

$${ɛ}_{1} = \frac{{T}_{1} + {α}_{2} {ɛ}_{2} + {α}_{3} {ɛ}_{3}}{- {α}_{1}}$$

$$Where \text{:}$$

$${T}_{1} = ln \vert T ( {λ}_{1} , {ɛ}_{1} , {ɛ}_{2} , {ɛ}_{3} ) \vert \cdot {L}^{- 1}$$

$${T}_{2} = ln \vert T ( {λ}_{2} , {ɛ}_{1} , {ɛ}_{2} , {ɛ}_{3} ) \vert \cdot {L}^{- 1}$$

$${T}_{3} = ln \vert T ( {λ}_{3} , {ɛ}_{1} , {ɛ}_{2} , {ɛ}_{3} ) \vert \cdot {L}^{- 1}$$

As can be seen, the concentrations of the fuel components are only dependent on the ratios between the absorption peaks C_{xy} (which are stored in a chemical reference library), the measured transmission T(λₘ, ε₁, ε₂, ε₃) and the length L which the light has to pass through the fuel.

We have chosen the following wavelengths which result in corresponding absorption factors:

2187 nm, α_{decane}=0,060 mm⁻¹, α_{octane}=0,071 mm⁻¹, α_{cumene}=0,428 mm⁻¹

2350 nm, α_{decane}=1,522 mm⁻¹, α_{octane}=1,032 mm⁻¹, α_{cumene}=0,888 mm⁻¹

2383 nm, α_{decane}=1,172 mm⁻¹, α_{octane}=0,961 mm⁻¹, α_{cumene}=0,498 mm⁻¹

I.e.:

αₗ=0,060 mm⁻¹, α₂=0,071 mm⁻¹, α₃=0,428 mm⁻¹

C₂₁=1,522/0,060=25,36, C₃₁=1,172/0,060=19,53

C₂₂=1,032/0,071=14,54, C₃₂=0,961/0,071=13,54

C₂₃=0,888/0,428=2,075, C₃₃=0,498/0,428=1,164

From FIG. 3 can be found that:

$$T ( 2187 nm ) = 90 , 4 \%$$

$$T ( 2350 nm ) = 28 , 3 \%$$

$$T ( 2383 nm ) = 36 , 1 \%$$

$$I . e . \text{:}$$

$${T}_{1} = - 0 , 1009 {mm}^{- 1}$$

$${T}_{2} = - 1 , 262 {mm}^{- 1}$$

$${T}_{3} = - 1 , 019 {mm}^{- 1}$$

$${ɛ}_{3} = \frac{\begin{matrix}- 1 , 019 - 19 , 53 \cdot ( - 0 , 1009 ) - \\ \frac{( 19 , 53 - 13 , 54 ) ( ( 25 , 36 \cdot - 0 , 1009 ) + 1 , 262 )}{( 14 , 54 - 25 , 36 )}\end{matrix}}{0 , 428 \cdot ( \begin{matrix}\frac{( 19 , 53 - 13 , 54 ) ( 25 , 36 - 2 , 075 )}{( 14 , 54 - 25 , 36 )} + \\ ( 19 , 53 - 1 , 164 )\end{matrix} )} = 0 , 100$$

Which gives:

$${ɛ}_{2} = \frac{\begin{matrix}25 , 36 \cdot ( - 0 , 1009 ) + 1 , 262 + \\ ( 25 , 36 - 2 , 075 ) \cdot 0 , 428 \cdot 0 , 100\end{matrix}}{0 , 071 \cdot ( 14 , 54 - 25 , 36 )} = 0 , 391$$

$$And \text{:}$$

$${ɛ}_{1} = \frac{- 0 , 1009 + 0 , 071 \cdot 0 , 391 + 0 , 428 \cdot 0 , 100}{- 0 , 060} = 0 , 506$$

With other words, the concentration of the materials is calculated to be 10% Cumene, 39% Octane and 51% Decane with the basis of the transmission curve which is given in FIG. 3. As we can see the accuracy is within 1% of the correct value in this example.

There are two ways to increase the accuracy of the measurement of the measuring in this example:

1) Use a larger number of correct decimals in the measurement (improved signal/noise ratio in a real measurement)

2) Several transmission measurements can be performed, either at several wavelengths or by measuring again at the same wavelengths several times (time averaging). With enough measurements, the result is a static distribution of the values. The average of these values will improve the result.

FIG. 4 shows measured transmission for 50% methanol and 50% ethanol in water, and pure distilled water for comparison. In addition to pure gasoline, alcohols can be dissolved in water and vise versa. In such circumstances you must take into consideration that water will absorb in certain regions at measurement, i.e. in situations where there is water present in the fuel.

The concentration measurements for the fuel are intended to be utilized to provide data for different applications. Both in relation to a more correct pricing of the fuel and in relation to control of the engine, the user will have benefit from this. For motor control it is important to have control of optimal combustion. This can be done by using the fuel data in a model where you have optimized motor parameters for the different fuel compositions.

The data thus make the control system capable of adjusting the motor to an optimal position by adjusting these parameters on the basis of the fuel composition.

FIG. 2 shows the chemical library, where some of the data is used in the example. The library contains typically all the fuel components one wishes the system to take into consideration.

### MODIFICATIONS

Alternative embodiments can be:
i) Increasing the accuracy of the measurement by using a narrow banded laser,
ii) Increasing the accuracy of the measurement by using a junction laser,
iii) Using deconvolution of absorbance or the transmission curves of the different fuel components,
iv) Frequency filtering the measured signal by amplitude modulating the laser,
v) Increasing or reducing the pressure to transform the fuel to gas or liquid phase,
vi) Increasing or reducing the temperature to transform the fuel to gas or liquid phase.

### REFERENCES

1. Patent No. 20051589: “En ny type laser”

2. N. J. Micyus, J. D. McCurry, J. V. Seeley: “Analysis of aromatic compounds in gasoline with flow-switching comprehensive two-dimensional gas chromatography”, pp. 115-121, Journal of Chromatography A, Vol. 1086 (2005)

3. K. M. Van Geem, D. Hudebine, M. F. Reyniers, F. Wahl, J. J. Verstraete, G. B. Marin: “Molecular reconstruction of naphtha steam cracking feedstocks based on commercial indices”, 15 pages, Computers and Chemical Engineering (2006), doi:10.1016/j.compchemeng.2006.09.001

1. Method for analyzing a fuel, preferably hydrocarbons, characterized in that the method includes the following steps:
a) Tuning of a laser to send out different wavelengths of light,
b) Illumination with the laser light of a chamber or container/flow line holding fuel,
c) Measuring of transmitted laser light after it has passed the chamber/container/flow line with an optical detector,
d) Collecting and storing of measurements,
e) Analyzing the measurements by means of a microcontroller,
f) Calculate the concentrations by means of an algorithm arranged in the microcontroller and a chemical reference library.

2. Method according to claim 1, characterized in that some of the light is used for the measuring of a light signal through a reference material.

3. Method according to claim 2, characterized in that the measurements from the reference material are used to determine the real wavelength of the light.

4. Method according to claim 1, characterized in that the laser alters wavelength/is tuned by changing current and/or temperature.

5. Method according to claim 1, characterized in changing work cycle by altering work cycle and pulse current of the laser.

6. Method according to claim 5, characterized in that the signal from the detector is filtered according to the pulse frequency of the laser.

7. Method according to claim 1, characterized in that the fuel is gasoline, ethanol, methanol or mixtures of these.

8. Method according to claim 1, characterized in that the fuel is in gas form due to pressure or temperature conditions.

9. Method according to claim 1, characterized in that spectral region is chosen such that the fuel components have medium absorption in at least a part of the spectral region.

10. Method according to claim 1, characterized in that there are at least as many measuring points as fuel components.

11. System for performing the method according to the claims 1-10, characterized in that the system includes:
a chamber or a container/flow line or similar, through which chamber or container/flow line (10) a fuel flows,
one or more tunable lasers (11) and one or more detectors (12).

12. System according to claim 11, characterized in that the system further includes a reference cell arranged in relation with the laser, through which reference cell a part of the light from the laser passes.

13. System according to claims 11 and 12, characterized in that the system further includes a microcontroller (13) having external or internal memory.

14. System according to claims 11-13, characterized in that the microcontroller (13) is provided with algorithms for measuring, storing of measurements, analyzing measurements and calculating concentrations of fuel components.

15. System according to claim 11, characterized in that the angle cp between the laser light and the chamber/container/flow line (10) is chosen such that reflected light does not affect the laser.

16. System according to claim 11, characterized in that the laser (11) is narrow banded laser or a junction laser or similar.

17. System according to claim 11, characterized in that the chamber/container/flow line (10) or similar is transparent.
